(19) United States
(12) Patent Application Publication
(10) Pub. No.: US 2010/0057566 A1
(43) Pub. Date: Mar. 4, 2010

(54) SYSTEM AND METHOD FOR MULTIPLE LAYERED PAY-PER-CLICK ADVERTISEMENTS

(76) Inventor: Oded ITZHAK, Hoboken, NJ (US)

Correspondence Address: Pearl Cohen Zedek Latzer, LLP, 1500 Broadway, 12th Floor, New York, NY, 10036, US

(21) Appl. No.: 12/553,444

(22) Filed: Sep. 3, 2009

Related U.S. Application Data
(60) Provisional application No. 61/093,869, filed on Sep. 3, 2008.

(51) Int. Cl. G06Q 30/00; G06F 3/048

(52) U.S. Cl. 705/14.53; 705/14.69; 715/781; 715/856

(57) ABSTRACT

A system and method for providing advertisements in a web page including transmitting a message or advertisement including a sequence of a plurality of layers to the web page, each sequential layer being displayed in response to a user selection of the preceding layer. A client may be charged a fee for the advertisement when the user selects a predetermined number of sequential layers. The client may be charged a fee for the advertisement when the user selects a last one of the sequence of the plurality of layers to click through to the client web site. A user computer may send an advertisement server data relating to the web site content and the advertisement server may send the user computer advertisements related to the web site content.

### PRIOR APPLICATION DATA

The present application claims the benefit of prior U.S. provisional application Ser. No. 61/093,869, filed Sep. 3, 2008, and entitled “System and Method for Dynamic Placement of Advertisements between Document Paragraphs,” incorporated by reference herein in its entirety.

### FIELD OF THE INVENTION

The present invention relates to methods and systems for providing and operating online advertisements, for example advertisements targeted to users based on the web page content.

### BACKGROUND

In-text advertising is a form of targeted advertising using the World Wide Web (“Web”) in which advertising systems scan website content for keywords and return advertisements to website pages based on the keywords. For example, if the user is viewing a sports website, sports-related advertisements, such as memorabilia dealers or ticket sellers, may be integrated into the website. Advertisements may be displayed as “pop-up” advertisements that expand when the user drags a pointer (e.g., an on-screen indicator such as a cursor or arrow) controlled by a pointing device (e.g., a mouse) across the target keyword on the website page.

Web advertising has become so wide-spread over the past decade that most commercial websites feature advertisements. However, website advertisements are often burdensome to users. Some website advertisements block or obstruct users' ability to navigate a web page and, in some cases, mislead users into purchasing goods or accessing unwanted information. As a result, website advertising has become an annoyance for many users who avoid accessing pop-up advertisements and web links. Accordingly, advertisers are wary of website advertising and the price of the advertisements has been devalued.

Accordingly, there is a need in the art to increase consumer confidence in website advertisements and ensure the advertisements reach the appropriate users.

### BRIEF DESCRIPTION OF THE DRAWINGS

Specific embodiments of the present invention will be described with reference to the following drawings, wherein:

FIG. 1 is a schematic illustration of a system for providing advertisements over the a network such as the World Wide Web (“Web”) in accordance with an embodiment of the invention;

FIG. 2 is a schematic illustration of Web resources used in conjunction with the system of FIG. 1 in accordance with an embodiment of the invention;

FIG. 3 is a schematic illustration of an advertisement including multiple sequential layers of content in accordance with an embodiment of the invention;

FIGS. 4A and 4B are schematic illustrations of a “pop-up” advertisement in two respective modes in accordance with an embodiment of the invention;

FIGS. 5A and 5B are schematic illustrations of a “switch” advertisement in two respective modes in accordance with an embodiment of the invention;

FIGS. 6A and 6B are schematic illustrations of client enrollment web pages provided for a client to design, target, and purchase Web advertisements in accordance with an embodiment of the invention; and

FIG. 7 is a flowchart illustration of a method in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### SUMMARY OF THE INVENTION

In an embodiment of the invention, a web advertisement may be provided in a web page. The advertisement may be transmitted to a location, for example, a user computer. The advertisement may include a sequence of a plurality of layers. Each sequential layer of the advertisement (after the first layer, which is initially displayed) may be displayed in response to a user selection of the preceding layer. A fee may be charged to a client for the advertisement when the user selects a predetermined number of sequential layers. A client may be charged a fee when a user selects a last one of a sequence of layers, e.g. to click through to the client web site.

In an embodiment of the invention, a web advertisement may be provided in a web page. Web site code from a web site server may be executed to display web site content in the web page. An advertisement may be received from an advertisement server. The advertisement may include a sequence of a plurality of layers. Each sequential layer of the advertisement (after the first layer) may be displayed in response to a user selection of the preceding layer. Advertisement code from the advertisement server may be executed to display at least an initial layer of the advertisement separately from the web site content.

In an embodiment of the invention, a system may provide a web advertisement in a web page. The system may include a server to transmit the advertisement and code to a location. The advertisement may include a sequence of a plurality of layers. The code may enable each sequential layer (after the first layer) to be displayed in response to a user selection of the preceding layer, for example by clicking or moving the a pointer controlled by a device such as a mouse over the preceding layer. The system may include a processor to charge a client a fee for the advertisement when the user selects a predetermined number of sequential layers. In one embodiment, the processor may charge a client a fee for the advertisement when the user selects the last or final advertisement layer in the sequence of layers, for example, selecting to be directed to the advertiser web site.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention include a system and method for dynamically matching, linking or distributing messages such as third-party advertisements to web pages based on, for example, textual information, subject information, or content of the web pages, and in addition for syndicating or distributing those messages or advertisements for display into the web pages. In some embodiments, the publisher of a web page's content may enroll in advance with a service or server to provide the matching and possibly receive code, a plug-in, or a link for incorporation into or use with the web page that enables the web page to retrieve related advertisements from a separately hosted application. Advertisers may bid on content categories that correspond to web pages within web sites to display their advertisements.

Some embodiments of the invention relate to increasing consumer confidence in Web advertising for both the Web user and advertisers. For this reason, in some embodiments, messages such as Web advertisements may be located separately from and/or peripheral to the standard content in a web page. By providing a separation between web content and advertisements, a user is less likely to accidentally view advertisements as compared with prior art systems, in which advertisements are often tagged to keywords or otherwise mixed within web page content. Another mechanism for ensuring that users intentionally view advertisements includes, in accordance with some embodiments of the invention, providing advertisements, in which each advertisement has multiple sequential levels or layers of content. Each sequential layer after the first layer may be displayed, e.g., one at a time or cumulatively, in response to a user selecting, clicking, “rolling over” or otherwise indicating the preceding layer (the first layer is initially displayed not in response to user input). When used herein, “clicking” on a screen item may mean, while a pointer or cursor is over or on the item on a screen display or monitor, a user operating a pointing device (e.g. a button on a mouse), touching a touch screen, or providing another selection indication. Each time a user selects a layer, an additional advertisement layer may be displayed. In this way, the user controls the level of their exposure to the advertisement content, while ensuring that advertisers pay only for clicks that occur after users express an interest in the advertisement by interacting with or selecting preceding layers. An advertising fee may be charged to a client advertiser based on the number of advertisement layers a user selects, which corresponds to their level of advertisement exposure. By giving users control over their exposure to advertisement, advertisers may be assured that advertisements, if viewed, are intentionally viewed and therefore more valuable than other Web advertisements known in the art. Advertisers may be charged, for example, when users click on the last layer of the advertisement, and may thereby be assured that they are only paying for clicks by users that express an interest in their advertisement.

When used herein, an advertisement (“ad”) may be, for example, a single sentence describing a product or a service, or a more detailed textual description of a product or service that consists of at least a title and a description of the product or the service. Other implementations such as graphical ads, or other types of advertisements, may also be used. In one embodiment, a textual advertisement message limited to, for example, 50 characters, is displayed on a web page, and when a user clicks (e.g., by using a pointing device such as a mouse, or another method) on or moved the mouse or pointing device over the ad message, additional information such as a title, a description, an image, etc. may be displayed to the user, for example, in the same space where the initial advertisement message is displayed or in a separate window (e.g., a small window).

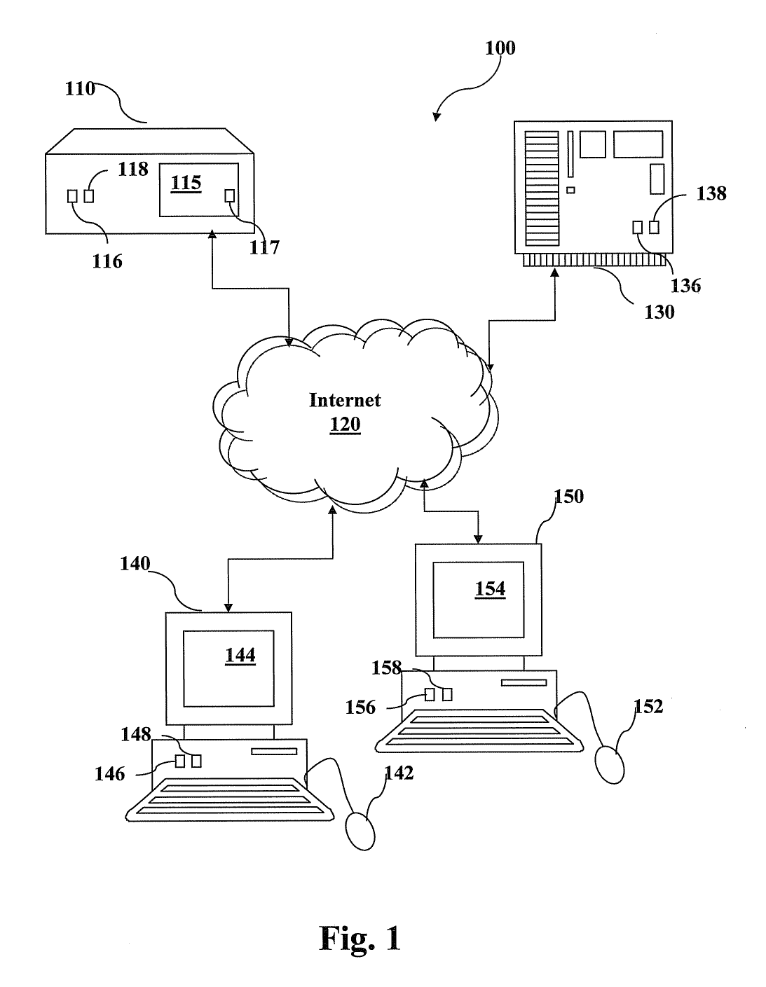

Reference is made to FIG. 1, which schematically illustrates a system 100 for providing messages such as advertisements over a network such as the World Wide Web (“Web”) in accordance with an embodiment of the invention. System 100 may include a server 110 for hosting or distributing advertisements over the Web, an associated database 115, a Web host 130, a user computer 140, and a client or advertiser computer 150, all of which are connected via a network 120 such as the Internet.

Server 110 may include a computing device for hosting and distributing webpage advertisements over network 120 according to embodiments disclosed herein. Server 110 may include applications for interacting with user computer 140 and advertiser computer 150.

Database 115 may include software processes or applications for storing and retrieving message or advertisement data 117 for generating messages such as advertisements. Advertisement data 117 may include data associated with each advertisement, such as a list of web content categories to which the advertisements are targeted and statistical data relating to a usage history for each advertisement. Advertisement data 117 may also include code (e.g., software code) or logic, e.g., to enable interactive display features, such as, to expand a pop-up window advertisement or to display additional layers of the advertisement within the same area, when a cursor or pointer controlled by a user pointing device passes over an area of a web page designated for displaying advertisements. Database 115 may be internal or external to server 110 and may be connected thereto by a local or remote and a wired or wireless connection. In alternate embodiments, advertisement data 117 may be stored in an alternate location separate from database 115, e.g., memory unit(s) 118.

One or more user computer(s) 140, e.g., controlled by a user, may access websites and web pages hosted by Web host 130 via network 120. Server 110 may include applications for retrieving and viewing web content on user computer 140. The advertisements displayed within web pages on user computer 140 may be targeted to match the web content retrieved from user computer 140. For example, server 110 may include applications capable of generating code or plug-ins in a programming language compatible with incorporation on certain websites, such as, for example, in JavaScript.

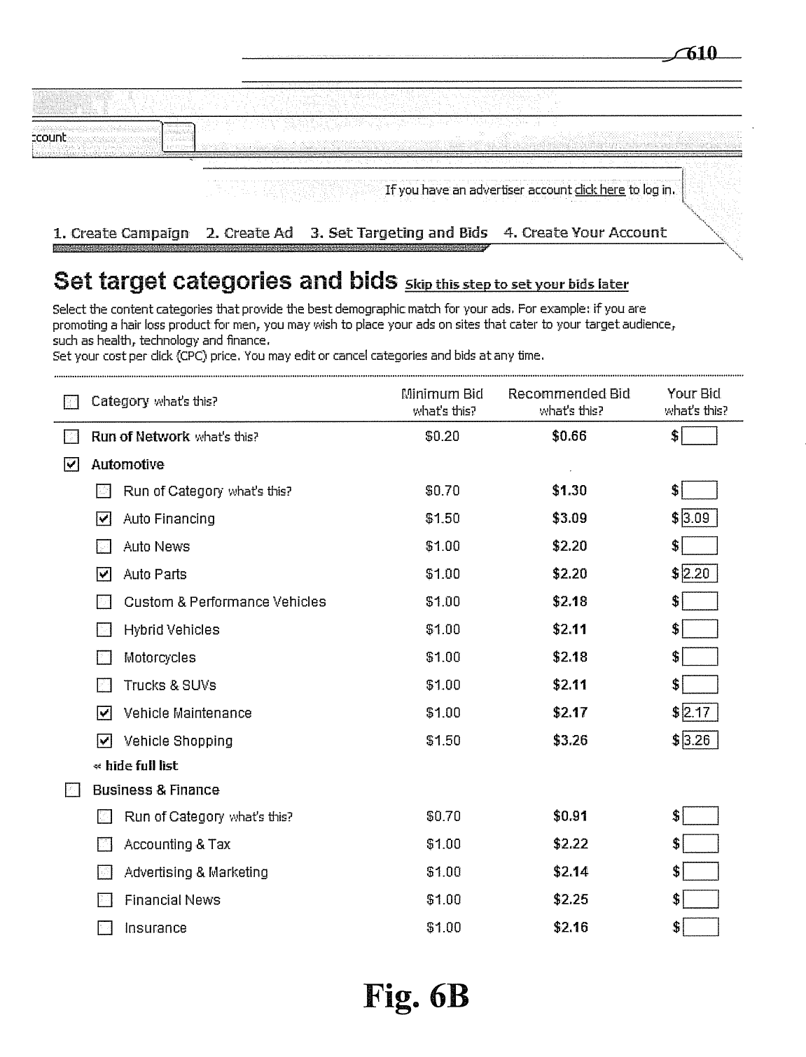

One or more advertiser computer(s) 150 may be operated by advertisers to design, target and purchase Web advertisements. Server 110 may provide advertiser computer 150 with a series of design, target and purchasing options, e.g., as described in reference to FIGS. 6A and 6B. An advertiser may be a client of the organization operating server 110.

User computer 140 and advertiser computer 150 may be personal computers, desktop computers, mobile computers, laptop computers, and notebook computers or any other suitable device such as a cellular telephone, personal digital assistant (PDA), video game console, etc., and may include wired or wireless connections or modems. User computer 140 and advertiser computer 150 may include one or more input devices 142 and 152, respectively, for receiving input from a user (e.g., via a pointing device, click-wheel or mouse, keys, touch screen, recorder/microphone, other input components). User computer 140 may include one or more output devices 144 (e.g., a monitor or screen) for displaying to a user web pages hosted by web host 130 having messages such as advertisements provided by server 110 embedded therein. Advertiser computer 150 may include one or more output devices 154 for displaying to a client advertiser an interface having entry fields and uploading capabilities for designing, selecting and purchasing advertisements.

Web host 130 may include a computer or computer system capable of hosting a web site, typically composed of one or more web pages, as is commonly known in the art. Each web page may be written in Hypertext Markup Language (HTML) or other suitable language as is known. A web page may also include one or more frames for displaying additional content not present on the web page.

Network 120, which connects server 110, web host 130, user computer 140 and advertiser computer 150, may be any publicly accessible network such as the Internet. Access to network 120 may be through wire line, terrestrial wireless, satellite or other systems well known in the art.

Server 110, web host 130, user computer 140, and advertiser computer 150, may include one or more controller(s) or processor(s) 116, 136, 146, and 156, respectively, for executing operations and one or more memory unit(s) 118, 138, 148, and 158, respectively, for storing data and/or instructions (e.g., software) executable by a processor. Processor(s) 116, 136, 146, and/or 156 may include, for example, a central processing unit (CPU), a digital signal processor (DSP), a microprocessor, a controller, a chip, a microchip, an integrated circuit (IC), or any other suitable multi-purpose or specific processor or controller. Memory unit(s) 118, 138, 148, and/or 158 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

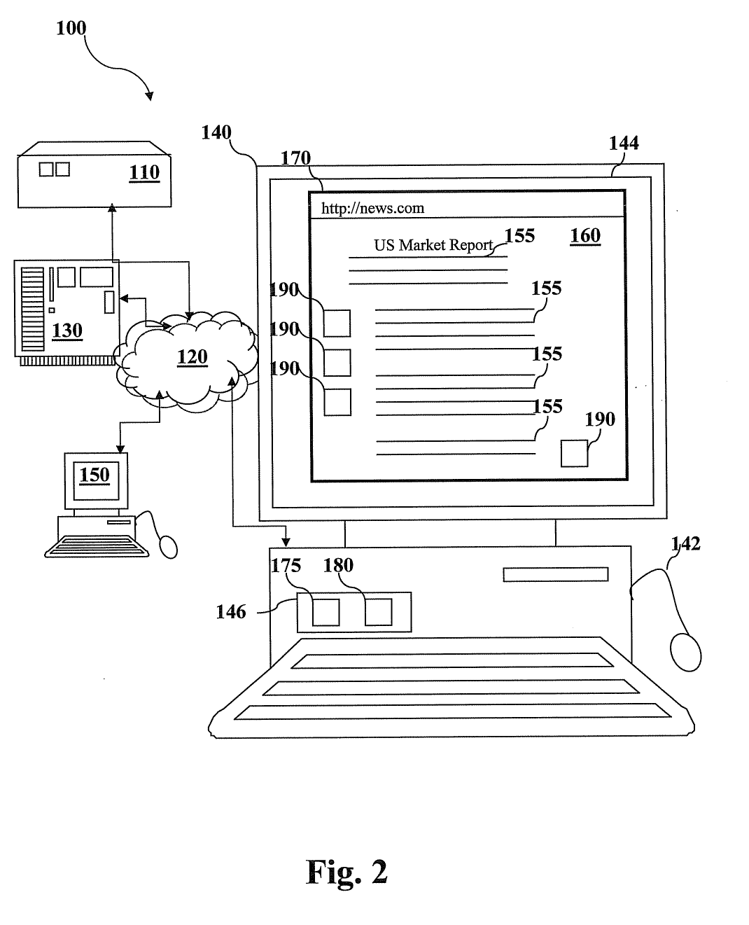

Reference is made to FIG. 2, which schematically illustrates Web resources used in conjunction with system 100 of FIG. 1 in accordance with an embodiment of the invention. User computer 140 may operate processor(s) 146 to load a web page 160 from a web site with a web browser 170 from web host 130 transmitted over network 120. Web page 160 may include code 175 for operating standard web page content 155 and code 180 for displaying one or more advertisements 190 within web page 160. Code 175 and code 180 may be loaded and stored in memory unit(s) 148, for example, at least temporarily while user computer 140 uses the corresponding web site.

Web site owners may incorporate code 180 into their web page 160 to sell advertisement space and generate revenue or profit. In some embodiments, the web site owners may enroll in advance with a service or server (e.g., server 110) to receive code 180 in a programming language compatible with incorporation on certain websites, such as, for example, in JavaScript. Code 180 may be generated for example manually or automatically. For example, such code 180 may be generated by a self-service tool or software agent. Code 180 may be incorporated in web page 160 for example manually or automatically. A web site owner may connect to server 110, which may provide code 180 or a plug-in to be inserted in the web site.

Processor(s) 146 may operate web browser 170 (which itself may be executable code stored in memory) to load web page 160 on user computer 140 and to invoke code 180, which in turn calls server 110 to retrieve advertisement data 117 corresponding to a set of advertisements 190 to be displayed in web page 160 on user computer 140. Server 110 receives a request from user computer 140 to serve advertisements to be displayed on web page 160. The request may include any parameters or information, such as the number of advertisements, the IP address of the user viewing the page, information about the user's browser, geographic location of the user, descriptive information that describe the web page content 155 of web page 160, a customer ID, a user identification code, a security code, the URL of the web page, a list of keywords or metadata from web page 160 as is known in the art, and/or content from web page 160.

In some embodiments, upon receipt of a request to server 110, processor 116 (or another unit) may select which advertisements to serve to user computer 140 based, for example, on statistical data relating to each advertisement (e.g., data 117). Statistical data may include, for example, the number of times the advertisement was displayed on the website or on user computer 140, the number of clicks on the advertisement, the average cost per click, a click-through rate etc. Statistical data may be computed for each advertisement across all web pages where the advertisements was displayed or per specific sets of web pages. For example, an advertisement that promotes a car insurance company may have been displayed on different web pages in the news relating to different categories, for example, finance and health categories. In this case, a different set of statistical data may be stored for that advertisement for each content category. Additionally, statistical data may also be stored separately for different time periods. Statistical data may be stored as data 117 in database 115 or another memory location accessible to server 110, such as memory unit 118. Other information may be used to decide which advertisement to serve to a user computer.

Given a request for server 110 to serve advertisements for a specific web page 160, processor 116 may, for example, classify web page 160 by one or more content categories, and retrieve advertisement data 117 associated with that content category or that have a history log of performing well with that content category based on the statistical data for that category. Related or relevant advertisements or messages may be served. For example, processor 116 may analyze statistical data such as click-through rates and cost-per-click rates to determine which advertisements assigned to a web page with a given category have a probability of performing above a predetermined threshold or relatively better than other advertisements displayed on that web page. Any set of web pages 160 or web page content 155 may be classified automatically by one or more content categories. In some embodiments, processor 116 may calculate a weight for advertisement data 117 corresponding to each advertisement 190 based on its statistical data and other parameters and may use such a weight to determine a probability of the advertisement to be clicked or otherwise selected by an end user.

In some embodiments, processor 116 may classify pages to a predefined set of categories using text classification algorithms known in the art. In other embodiments, processor 116 may dynamically cluster pages into a set of clusters based on their content using clustering algorithms known in the art. Server 110 may use other methods to select which advertisements 190 to serve.

In some embodiments, upon receiving advertisement data 117 corresponding to a set of advertisements 190 from server 110, processor 146 may execute code 180 to place the advertisements 190 within web page 160, causing text or graphics (e.g., of a certain level or layer) of an advertisement to be displayed on the monitor 140 along with the content 155. If there are multiple advertisements, processor 146 may invoke code 180 to additionally order advertisements 190. In one embodiment, the exact display or on-screen location of advertisements 190 may be pre-designated by a website designer and specified in the website code 175. In this embodiment, processor 146 may invoke code 180 may place advertisements 190 in the pre-designated areas of a display or monitor. Alternatively, website code 175 may not designate an exact advertisement area and processor 146 may use code 180 to determine the position of advertisements 190.

In one embodiment, processor 146 may use code 180 to automatically place the advertisements in web page 160 separate from the web page content 155. User computer processor 146 or server processor 116 may use code 180 to identify and determine the dimensions of blocks of text, web links, HTML tags, scripts and/or other non textual elements of web page content 155. Code 180 may be executed by processor 146 to insert advertisements 190 outside of the on-screen or on-monitor boundaries of web page content 155. By providing a separation between web page content 155 and advertisements 190, a user is less likely to accidentally view advertisements as compared with prior art systems.

In some prior art systems, advertisements are tagged to keywords or otherwise mixed in with web content. Such advertisements are often marked by highlighting or double-underlining the tagged keyword. However, some conventional web pages similarly highlight or underline keywords for other purposes, e.g., to provide more detailed information about the subject matter of the keyword. Users may confuse these informational keyword links with in-text advertisements and unintentionally view the advertisements.

A goal of some embodiments of the invention is to reduce accidental advertisement exposure in order to increase advertiser confidence that users are intentionally accessing advertisements. Advertisers may in turn pay a higher price for advertising. According to embodiments of the invention, by providing advertisements 190 separately from the web page content 155 or by labeled advertisements 190 as “advertisement,” a user is more often aware that they are accessing advertisement 190. Web page content 155 and advertisements 190 may be considered separate when they are, for example, spaced by a gap, non-overlapping, non-connected, separated by a border, line, or area, e.g., when viewed on a screen.

In one example, code 180 may position advertisements 190 at the periphery of web page 160, e.g., peripheral to the entire web page content 155 as a whole, e.g., to its right, left, top, or bottom. In another example, code 180 may position advertisements 190 within the boundaries of the content as a whole, but outside of sub-sets or blocks of web page content 155, for example, in between paragraphs of web page 160. In this example, processor 146 may execute code 180 to count the total number of characters in all blocks of text on the page, possibly ignoring blocks of texts that include little amount of text (for example, less that 100 characters). In some embodiments, calculation of the amount of text in a block of text may be done after removing links, HTML tags, scripts and other non textual elements from the block. Processor 146 may then execute code 180 to, for example, divide the total character count by the number of advertisements 190 served plus 1 to calculate an interval that will be used to distribute advertisements 190 on web page 160. Processor 146 may then execute code 180 to place advertisements 190 immediately following paragraphs of text (e.g., blocks of text that have large amount of textual characters after removing links, tags, scripts etc), while ensuring that the number of characters between any two adjacent advertisements will not be less than the above mentioned interval. Other Intervals may be used.

Whether advertisements 190 are placed to the periphery of web page 160 or in between paragraphs, advertisements 190 are positioned separately from standard web page content 155. For example, advertisements are preferably not linked to any keywords or positioned within sentences and/or paragraphs of web page content 155. In this way, accidental selection of advertisements is reduced as compared to in-text, keyword link, and other advertisement systems known in the art. In alternate embodiments, advertisements or messages displayed according to some embodiments may be integral with the text or graphics of a displayed web page.

In some embodiments, code 180 may position advertisements 190 in a location or order (separate from web page content 155) that maximizes the probability of the greatest number of advertisements 190 being selected by users.

Web page content 155 or “core content” may include content provided by web host 130, content designed by the website owner, and/or content that may be permanently or semi-permanently displayed on web page 160. Web page content 155 in some embodiments does not include advertisements 190 since advertisements 190 are typically not provided by web host 130, but by sever 110, advertisements 190 are typically not designed by the website owner, but by a third-party advertising advertiser, and advertisements 190 are typically not permanently or semi-permanently displayed on web page 160, but may change each time website 160 is loaded based on the enrollment plans of advertisers and the most recent statistical data related to the performance of advertisements 190. In some embodiments, the distinction or separation between core content and messages or advertisements may not be used.

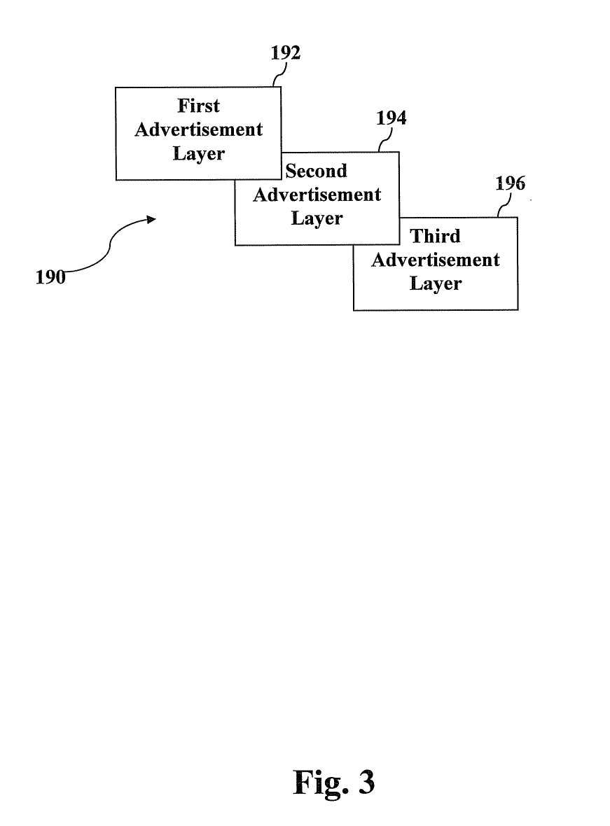

Reference is made to FIG. 3, which schematically illustrates a message or advertisement 190 including multiple sequential levels or layers 192, 194, and 196 of content in accordance with an embodiment of the invention. Levels or layers 192, 194, and 196 may be substantially the same or different sizes and may be positioned in substantially the same or different on-screen locations.

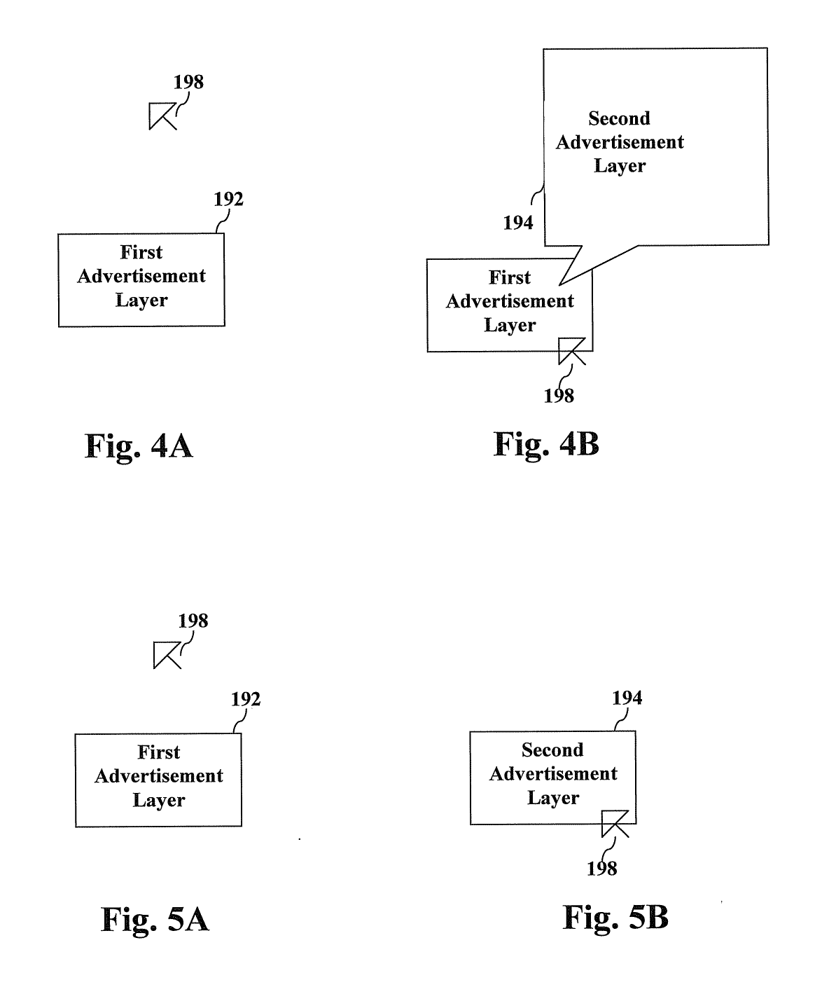

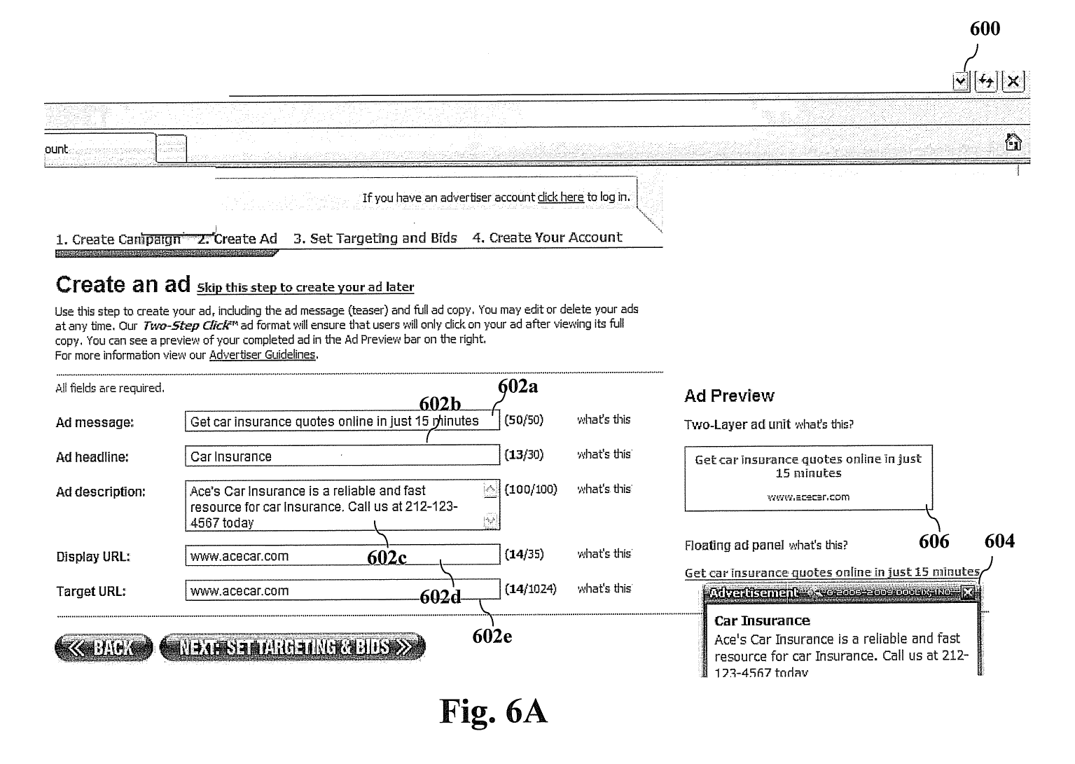

In one embodiment, each sequential layer 192, 194, and 196 may provide a greater amount of advertisement content, e.g., in total or relative to each other, or may be a different format of content (e.g., text, video, audio, etc.), or a different format of presentation (e.g., embedded messages, advertisements, flashing advertisements, scrolling advertisements, “pop-up” advertisements (an example of which is shown in FIGS. 4A and 4B), “switching” advertisements (an example of which is as shown in FIGS. 5A and 5B), or other advertisement formats) as compared to the previous layer. A sequential advertisement layer of layers 192, 194, and 196 may take up more space on the display or monitor than a preceding layer, and may be displayed on top of (overlaying and obscuring) a previous layer, but need not. For example, a first layer 192 may be a few words or a small graphical image occupying a small space, and a second layer 194 may expand the portion of the screen devoted to the advertisement or may be an overlay. Other numbers of levels or layers may be used.

Advertisement data 117 may include code or logic for displaying each sequential layer (after or including the first layer) of advertisement 190 in response to a user selection of the preceding layer. Alternatively code 180 may include such logic. A user may select a sequential advertisement layer using input device 142, e.g., by “clicking” or “rolling-over” the current layer with a cursor or pointer directed by a mouse, stylus, or pointer, by touching a touch-screen or other command devices. A user selection of a layer may include, while a pointer controlled by a pointing device or input device 142 is on the area of the webpage where the advertisement is displayed, receiving a user indication to the pointing device. Each advertisement layer 192, 194, and 196 may be displayed one at a time (the next advertisement layer replacing the previous advertisement layer) or cumulatively (the next advertisement layer displayed in addition to the previous advertisement layer).

By selecting each sequential advertisement layer, the user may incrementally and repeatedly reveal additional data related to advertisement 190. In this way, by providing multiple advertisement layers 192, 194, and 196 with relatively increasing amount of content where each sequential level is triggered by a user selection, the user may select the degree or extent of advertisement 190 to which they are exposed. Since users have control over their exposure to advertisement 190, advertisers may be assured that advertisements 190, if viewed, are intentionally viewed and therefore more valuable than advertisements known in the art. In one embodiment, when a user clicks on the last layer in the sequence of layers 192, 194, and 196, the user may be redirected to an advertiser website (either in the same window or in a new browser window). The advertiser may be charged, for example, when the user selects or clicks on the last layer (e.g., a web link) to be redirected to the advertiser web site. In some embodiments, a cost per click price of advertisement 190 may depend on the number of times the last layer is selected.

Message or advertisement layers 192, 194, and 196 may be sequenced by order, size, index numbers, randomly, or by other methods. However, during transmission, advertising data 117 corresponding to layers 192, 194, and 196 need not be transmitted in the sequence with which the layers are displayed to a user (although they may be). For example, advertising data 117 corresponding to layers 192, 194, and 196 may be transmitted from server 110 together as a data package and then, after being received by user computer 140, separated and sequenced by processor 146.

In one example, advertisement 190 has two layers 192 and 194, the first layer 192 providing less content relative to the second layer 194. For example, the first layer 192 may be a single line of text (e.g., up to 50 characters), such as “Get a car insurance quote online in just 15 minutes” and the second layer 194 may provide a larger amount of content (e.g., up to 180 characters and optionally a logo, sound byte, and/or link to the advertiser web page). Code 180 may automatically embed the first layer advertisement 192 in webpage 160, i.e., based on the webpage content. Typically, no user selection is required to view the first layer advertisement 192. When a user selects the first layer advertisement 192, e.g., by clicking on or scrolling over the first advertisement layer 192, a second advertisement layer 194 is revealed or displayed. The second advertisement layer 194 may be displayed in for example a “pop-up” advertisement, a “switch” advertisement format, or using another method.

Reference is made to FIGS. 4A and 4B, which schematically illustrate a “pop-up” message or advertisement 190 in two example modes in accordance with an embodiment of the invention (other modes may be used). FIG. 4A shows the “pop-up” advertisement 190 when a pointing device 198 (e.g., a cursor controlled by a user via input device 142, such as, a mouse) is outside of the area in which a first layer 192 is displayed. In this case, only the first layer 192 is displayed. In FIG. 4B, when pointing device 198 selects the first layer 192 (via a user moving the pointing device so the cursor is over the layer 192), a second layer 194 of the “pop-up” advertisement is displayed. The second layer 194 of the “pop-up” advertisement format may include for example a window or bubble that is first displayed, or which expands, when the user (drags a pointing device) moves pointing device 198 so that a pointer moves across the first advertisement layer 192. This may, on the screen or display, partially or fully overlay or cover the previous layer, or may be displayed in a different place.

Reference is made to FIGS. 5A and 5B, which schematically illustrate a “switch” message or advertisement 190 in two respective modes in accordance with an embodiment of the invention. In FIG. 5A, when pointing device 198 is outside of an area in which advertisement 190 is displayed, a first layer 192 is displayed. In FIG. 5B, when pointing device 198 is inside of the area in which advertisement 190 is displayed, a second layer 194 is displayed. In the “switch” advertisement format, a two-layer advertisement is generated in a single location on web page 160. The two-layer advertisement switches between display of advertisement layers based on a user command, for example, switching between first and second advertisement layers 192 and 194 when the user indicator is off and on the advertisement location, as shown in FIGS. 5A and 5B, respectively. Other types of advertisement formats may be used, such as blinking two-layer advertisements (layers switch without being triggered by a user command), scrolling advertisements, etc.

Processor 146 may execute code 180 for user computer 140 to record and transmit to server 110 data associated with user selection of advertisements 190. For example, server 110 may receive data indicating the number of advertisement layers the user selects, the number of advertisement layers displayed to the user, the most sequential layer displayed, etc. In one embodiment, user computer 140 may transmit user selection data to server 110 for every instance, or alternatively for only a sub-set of select instances, in which a user selects a sequential level or layer. Server 110 may charge a client advertiser a fee when the user selects a predetermined one of the multiple advertisement layers or a multiple predetermined number of sequential advertisement layers. The client advertiser may not be charged until a user selects a certain number of multiple layers of advertisement content and/or click through to the advertiser website, and in this way, shows a sufficient level of interest in advertisement 190.

Processor 146 may execute code 180 to instruct user computer 140 to record and transmit advertisement 190 usage information to server 110. Server 110 may store and compile a usage history for each advertisement 190. The usage history for each advertisement 190 may include an absolute value, rate or frequency in which users select each advertisement layer and the advertisement as a whole, and/or the number of clicks on the last layer. The usage history for each advertisement 190 may be classified by the web content category, the position of advertisement 190 on web page 160, the user's web history and time spent on web page 160 featuring advertisement 190, and other data associated with the selection frequency of advertisement 190. In one example, if a user spends less than a predetermined period of time (e.g., 15 seconds) on web page 160, the record of the advertisement spot may be removed from the advertisement usage history.

Server 110 may charge advertisers based on the advertisement usage history, for example, according to: the cumulative number of advertisement layers 192, 194, and 196 selected by a user, the number of advertisement layers 192, 194, and 196 viewed by a user (e.g., an initial advertisement layer may be displayed automatically without being selected), a user selection of a specific one of the advertisement layers 192, 194, and 196 (e.g., the second advertisement layer 194), a cumulative number, rate or frequency of user selection of advertisement 190, any combination of these criteria, or other suitable criteria. In one example, an advertiser may be charged for advertisement 190 when a user clicks, rolls-over or otherwise selects second advertisement layer 194 of a two or more-layered advertisement. Since the advertiser is only charged after a user makes two selections of related advertisement layers (e.g., by rolling over the first layer 192 and then clicking on the second layer 194), the advertiser has a greater assurance that the user intentionally accesses these advertisements than if only one selection was made. The more assurance that the user intentionally accesses advertisements 190, the more valuable the advertisements become. The cost per click price of advertisement 190 may be affected by the advertisement's usage history.

In one embodiment, different advertisement layers 192, 194, and 196 may cost different amounts to display, e.g., the first advertisement layer 192 may be displayed on web page 160 at no cost, the second advertisement layer 194 may be displayed for $0.25, and the third advertisement layer 196 may be displayed for $1. The cost to display sequential advertisement layers 192, 194, and 196 may be constant, increase linearly, or preferably, increase exponentially, or by any other measure or rate. In some embodiments, the cost of displaying earlier advertisement layers in a sequence may be reduced if the cost of later advertisement layers is increased. For example, as compared with the previous example, the first and second advertisement layers 192 and 194 may be displayed for free while the third layer 196 is displayed for $5. Other or different prices, charges or fee calculations may be used.

It may be appreciated that charging a fee may include any mechanism to record, request or acquire a fee. For example, charging a fee may include simply accruing an amount in a client or advertiser account.

Alternatively or additionally, the usage history of advertisement 190 may be used by or sold to advertisers for market research to determine the extent to which users respond to their advertisements 190.

Reference is made to FIGS. 6A and 6B, which schematically illustrate advertiser enrollment web pages 600 and 610, respectively, in accordance with an embodiment of the invention. Server 110 may provide advertiser enrollment web pages 600 and 610 to advertiser computer 150 for an advertiser to design, target, and purchase Web advertisements 190. During this enrollment process, an advertiser may customize different attributes of advertisements 190 such as the maximum daily budget, content categories to which the advertisements are targeted, a cost-per-click bid for each category, etc.

In FIG. 6A, server 110 may provide advertiser computer 150 with web page 600 including a graphical user interface (GUI) 602 having entry fields or upload capabilities for creating advertisements 190. Web page 600 may include advertisement preview fields for viewing advertisement simulations in different formats, such as a pop-up advertisement format 604 and a “switch” advertisement format 606. The advertisement previews are preferably working simulations of what a user will view on user computer 140. When advertisements 190 have multiple advertisement layers 192, 194, and 196, separate design fields may be provided for each advertisement layer. In the example of FIG. 6A, design field 602a is provided for designing layer 192, design fields 602b and 602c are provided for designing layer 194, and design fields 602d and 602e are provided for designing layer 196. For example, design field 602a may provide space for 50 words, and design fields 602b and 602c may provide space for 13 and 100 words, respectively. Other number of characters and fields may be used. Any number of additional advertisement layers may be optionally generated at the advertiser's request. Audio and/or visual options may be provided or generated using tools provided by server 110 or shared from other applications.

In FIG. 6B, server 110 may provide advertiser computer 150 with web page 610 listing categories for targeting advertisements to web page content 155. The advertiser may select one or more categories of targeted web content by clicking adjacent data fields. Server 110 may determine which advertisements 190 to provide to web page 160 on user computer 140 based on the correspondence of the categories selected by the advertiser to the web page content 155 retrieved from user computer 140.

Targeting advertisements based on a content category may be advantageous over targeting based only on keywords. Keywords may have different meanings depending on their usage or context. For example, the keywords “support” and “tech” have different meanings in a news title “President will support tech bill” and in a company listing product information for “tech support for laptops and PCs”. Accordingly, targeting advertisements based on keywords alone, e.g., such as “in-text advertising,” may be an inaccurate mechanism for determining the relevance of an advertisement to a web page.

According to embodiments of the invention, by targeting advertisements 190 based on content categories of web pages 160, for which there is typically less ambiguity or confusion compared with targeting based only on keywords, advertisements 190 may more accurately match web page content 155. It may be appreciated that embodiments of the invention may determine advertisement relevance based on a (weighted or non-weighted) combination of content categories and keywords.

According to one embodiment of the invention, the advertiser may be charged when a user successively selects multiple layers of advertisement 190, e.g., and clicks on the last layer. In one embodiment, the advertiser may pay a flat fee for each category. In another embodiment depicted in FIG. 6B, the advertiser may bid on each content category. Accordingly, when advertisements from multiple advertisers correspond to the same web content, the advertiser that bids the highest amount may have his advertisement 190 displayed, for example, with greater priority or more often. Additionally or alternatively to the cost of an advertisement, advertisements 190 may be displayed with priority based on the advertisement usage history, e.g., if an advertisement had a greater number or rate of multiple “clicks” or selections than other advertisements.

It may be appreciated that a client advertiser may submit the aforementioned design, target, and purchase information via telephone or written request and it may entered directly into server 110 without using advertiser computer 150.

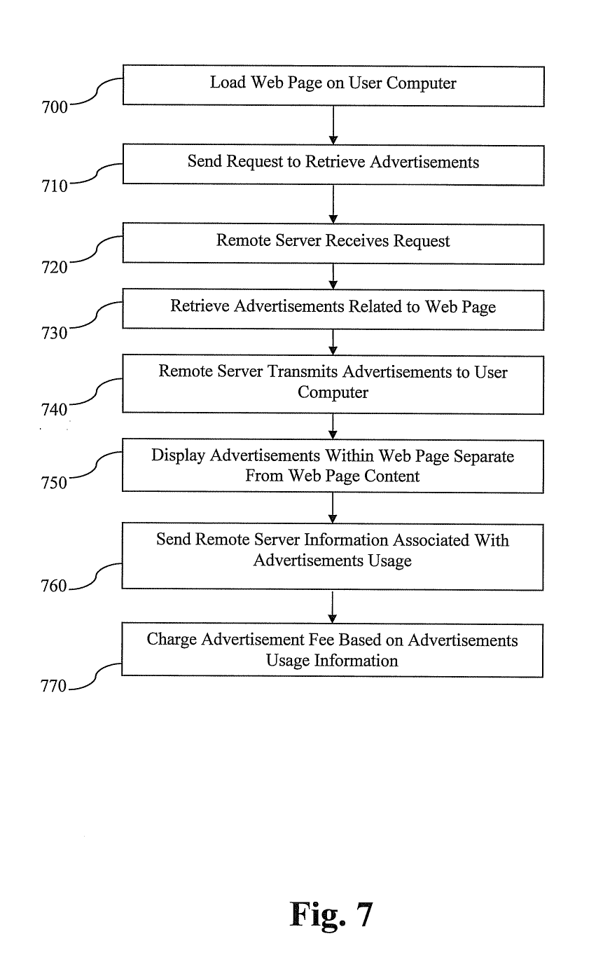

Reference is made to FIGS. 7, which is a flowchart of a method in accordance with an embodiment of the invention.

In operation 700, a user may load a web page from a web site with a web browser on a user computer from a web host transmitted over a network. The user computer may receive web site code from a web site server and execute the web site code to display web site content in the web page.

In operation 710, the web browser may invoke code, which in turn sends a request to a remote server to retrieve one or more advertisements to be displayed in the web page on the user computer. The request may include data relating to or including web site content.

In operation 720, the server receives the request from the user computer to serve advertisements to be displayed on the web page.

In operation 730, given a request to serve advertisements for a specific web page, the server may retrieve advertisements related or relevant to the web site content. The advertisements and the web page may each be associated with one or more content categories. The server may have a processor that determines and select advertisements associated with content categories that sufficiently match the web page categories. If there are more advertisements that match than there are advertisement spots available, the server may select a sub-set of the matching advertisements to be displayed, e.g., based on statistical data of the past performance of the advertisements.

In operation 740, the server may transmit the retrieved advertisements to the location, e.g., the user computer, which may be using the web page. The advertisements may have a sequence of a plurality of layers. The server may also transmit code to enable each sequential layer to be displayed in response to a user selection of the preceding layer.

In operation 750, the processor of the user computer may use the web browser to execute code, which may display the advertisements within the web page, in one embodiment in a location separate from the core content of the web page. In one embodiment, the code may enable the initial one of the plurality of layers to be displayed on the web page between paragraphs of the core content of the web page. In another embodiment, the code may enable the initial one of the layers to be displayed on the web page peripheral to the core content of the web page. In one embodiment, the code enables at least one of the sequential layers to be displayed as an expanding window in response to a user (dragging a pointing device across) moving a pointing device so a pointer moves across the preceding layer. In another embodiment, in response to a user command, the code enables two of the layers to switch between being displayed in a designated area of the web page.

In operation 760, the user computer may record and send the server information associated with the user usage of the advertisements. The user computer may transmit user selection data to the server for every instance, or alternatively for only a sub-set of select instances, in which a user selects a specific level or layer or a predetermined number of layers.

In operation 770, the server may charge a client advertiser a fee for the advertisements based on the user usage of the advertisements. For example, a processor in the server may charge a client advertiser a fee for the advertisement when the user selects a predetermined number of sequential layers. In one embodiment, the processor may charge a client advertiser a fee for the advertisement when the user selects the last or final advertisement layer in the sequence of layers, for example, clicking through to the advertiser web site.

Other operations of orders of operations may be used.

Various embodiments are discussed herein, with various features. However, not all features discussed herein must be in all embodiments. For example, in one embodiment, a web page may display a series of layers, but advertisements may be included in a web page using methods other than content-related serving. E.g., each web page may include the same or a random set of advertisements.

Although the particular embodiments shown and described above will prove to be useful for the many distribution systems to which the present invention pertains, further modifications of the present invention will occur to persons skilled in the art. All such modifications are deemed to be within the scope and spirit of the present invention as defined by the appended claims.

1. A method for providing advertisements in a web page, the method comprising:
transmitting an advertisement comprising a sequence of a plurality of layers to a location, each sequential layer after the first layer being displayed in response to a user selection of the preceding layer; and
charging a client a fee for the advertisement when the user selects a predetermined number of sequential layers.

2. The method of claim 1, comprising accepting at a server a request from a web page of a web site for an advertisement related to the web page.

3. The method of claim 1, wherein the advertisement and the webpage are each associated with one or more content categories, the method comprising determining that the advertisement is related to the web page when the content categories of the advertisement and the webpage sufficiently match.

4. The method of claim 1, wherein at least an initial one of the layers is displayed on the web page separately from the core content of the web page.

5. The method of claim 4, wherein the initial one of the layers is displayed on the web page between paragraphs of the core content of the web page.

6. The method of claim 4, wherein the initial one of the layers is displayed on the web page peripheral to the core content of the web page.

7. The method of claim 1, wherein at least one of the sequential layers is displayed as an expanding window in response to a user controlled pointer moving across the preceding layer.

8. The method of claim 1, wherein in response to a user command two of the layers are formatted to switch between being displayed in a designated area of the web page.

9. The method of claim 1, wherein the user selection of the layer comprises a pointer controlled by a pointing device passing over the area of the webpage where the advertisement is displayed.

10. The method of claim 1, wherein the user selection of the layer comprises, while a pointer controlled by a pointing device is on the area of the webpage where the advertisement is displayed, receiving a user indication to the pointing device.

11. The method of claim 1, wherein a client is charged a fee when the user selects a last one of the sequence of the plurality of layers to click through to the client web site.

12. A method for providing advertisements in a web page, the method comprising:
displaying web site content in the web page;
receiving an advertisement from a server, the advertisement comprising a sequence of a plurality of layers, each sequential layer after the first layer to be displayed in response to a user selection of the preceding layer; and
displaying at least an initial layer of the advertisement separately from the web site content.

13. The method of claim 12, wherein the initial one of the layers is displayed on the web page peripheral to the web site content of the web page.

14. The method of claim 12, wherein at least one of the sequential layers is displayed as an expanding window in response to a user causing a pointer to move across the preceding layer.

15. The method of claim 12, wherein in response to a user command two of the layers are formatted to switch between being displayed in an designated area of the web page.

16. A system for providing advertisements in a web page, the system comprising:
a server to transmit the advertisement and code to a location, the advertisement comprising a sequence of a plurality of layers, the code to enable each sequential layer after a first layer to be displayed in response to a user selection of the preceding layer; and
a processor to charge a client a fee for the advertisement when the user selects a predetermined number of sequential layers.

17. The system of claim 16, wherein the code enables at least an initial one of the layers to be displayed on the web page separately from the core content of the web page.

18. The system of claim 16, wherein the code enables at least one of the sequential layers to be displayed as an expanding window in response to a user causing a pointer to move across the preceding layer.

19. The system of claim 16, wherein in response to a user command, the code enables two of the layers to switch between being displayed in a designated area of the web page.

20. The system of claim 16, wherein the processor charges the client a fee for the advertisement when the user selects a last one of the sequence of the plurality of layers to click through to the client web site.
